(19) United States
(12) Patent Application Publication
(10) Pub. No.: US 2024/0128496 A1
(43) Pub. Date: Apr. 18, 2024

(54) ALL-SOLID-STATE SECONDARY BATTERY

(71) Applicant: TDK CORPORATION, Tokyo (JP)

(72) Inventors: Keiko TAKEUCHI, Tokyo (JP); Kazumasa TANAKA, Tokyo (JP); Keitaro OTSUKI, Tokyo (JP)

(73) Assignee: TDK CORPORATION, Tokyo (JP)

(21) Appl. No.: 18/277,615

(22) PCT Filed: Mar. 18, 2022
(86) PCT No.: PCT/JP2022/012731

§ 371 Date: Aug. 17, 2023

(30) Foreign Application Priority Data
Mar. 19, 2021 (JP) 2021-045819

(51) Int. Cl. H01M 10/0562; H01M 10/0525; H01M 10/0585

(52) U.S. Cl. CPC H01M 10/0562; H01M 10/0525; H01M 10/0585

(57) ABSTRACT

An all-solid-state secondary battery includes a laminate which includes a plurality of positive electrode layers each having a positive electrode active material layer, a plurality of negative electrode layers each having a negative electrode active material layer, and a plurality of solid electrolyte layers each containing a solid electrolyte, and in which the positive electrode layers and the negative electrode layers are alternately laminated with the solid electrolyte layers interposed therebetween, and the plurality of solid electrolyte layers include an outermost solid electrolyte layer disposed on both end sides of the laminate in a lamination direction and being thinnest among the plurality of solid electrolyte layers, and an inner solid electrolyte layer disposed inward relative to the outermost solid electrolyte layer and being thicker than the outermost solid electrolyte layer.

### TECHNICAL FIELD

The present invention relates to an all-solid-state secondary battery.

Priority is claimed on Japanese Patent Application No. 2021-045819, filed Mar. 19, 2021, the content of which is incorporated herein by reference.

### BACKGROUND ART

In recent years, developments in electronics technology have been remarkable, and portable electronic devices have become smaller and lighter, thinner, and more multifunctional. Along with that, there is a strong demand for batteries serving as power sources of electronic devices to be smaller and lighter, thinner, and more reliable. At present, commonly used lithium ion secondary batteries have conventionally used an electrolyte (electrolytic solution) such as an organic solvent as a medium for moving ions. However, in the battery of the above-described configuration, there is a likelihood that the electrolytic solution will leak out.

Also, since an organic solvent or the like used in the electrolytic solution is a combustible substance, it is required to further enhance the safety of batteries. Therefore, as one measure for enhancing the safety of batteries, it has been proposed to use a solid electrolyte instead of an electrolytic solution as the electrolyte. Further, development of an all-solid-state secondary battery in which a solid electrolyte is used as the electrolyte and other components are also formed of solids is underway.

For example, Patent Document 1 describes a point that, when two types of electrolytes with different porosities are provided, an internal stress applied to a solid electrolyte layer due to volumetric expansion and contraction can be alleviated, and charge/discharge cycle characteristics can be improved.

### CITATION LIST

### Patent Document

[Patent Document 1]
PCT International Publication No. WO 2013/175993

### Non-Patent Document

[Non-Patent Document 1]
Central Research Institute of Electric Power Industry, Report 2004 T03036

### SUMMARY OF INVENTION

### Technical Problem

However, in an all-solid-state secondary battery, heat is generated according to charging or discharging (Non-Patent Document 1). In regard to the heat generation, difficulty in dissipating heat suggests that a central portion of the battery is higher in temperature than an outer portion (peripheral portion). Generally, a capacity of an all-solid-state secondary battery increases when a temperature thereof becomes higher, but there is a tendency that deterioration also becomes faster, and cycle characteristics deteriorate. This problem cannot be solved by Patent Document 1.

An objective of the present invention is to provide an all-solid-state secondary battery having satisfactory cycle characteristics.

### Solution to Problem

In order to solve the above-described problems, the present invention provides the following means.
(1) An all-solid-state secondary battery according to a first aspect of the present invention includes a laminate which includes a plurality of positive electrode layers each including a positive electrode active material layer, a plurality of negative electrode layers each including a negative electrode active material layer, and a plurality of solid electrolyte layers each containing a solid electrolyte, and in which the positive electrode layers and the negative electrode layers are alternately laminated with the solid electrolyte layers interposed therebetween, and the plurality of solid electrolyte layers include an outermost solid electrolyte layer (having a thickness of tₐ) disposed on both end sides of the laminate in a lamination direction and being thinnest among the plurality of solid electrolyte layers, and an inner solid electrolyte layer (having a thickness of t_{b0} (1≤n)>tₐ) disposed inward relative to the outermost solid electrolyte layer and being thicker than the outermost solid electrolyte layer.
(2) The all-solid-state secondary battery according to above-described aspect may include a plurality of inner solid electrolyte layers being thicker than that of the outermost solid electrolyte layer, in which in the plurality of inner solid electrolyte layers, an inner solid electrolyte layer disposed closer to a central portion in the lamination direction may be thicker.
(3) The all-solid-state secondary battery according to above-described aspect may include a plurality of inner solid electrolyte layers having a thickness larger than that of the outermost solid electrolyte layer, wherein when in the plurality of inner solid electrolyte layers a thickness of an n-th inner solid electrolyte layer is t_{bn}, the n-th inner solid electrolyte layer being a n-th layer counted from the inner solid electrolyte layer disposed at the central portion in the lamination direction, and the following expression may be satisfied.

t_{b(n+1)}<t_{bn}<t_{b(n+1)}×2
(4) In the all-solid-state secondary battery according to above-described aspect, when a total number of the outermost solid electrolyte layers and the inner solid electrolyte layers is p, and the number of the inner solid electrolyte layers is q, the following expression may be satisfied.

3≤q≤p−2
(5) In the all-solid-state secondary battery according to above-described aspect, the solid electrolyte may have a crystal structure of any one of a NaSICON type, a garnet type, or a perovskite type.

### Advantageous Effects of Invention

According to the present invention, it is possible to provide an all-solid-state secondary battery having satisfactory cycle characteristics.

### BRIEF DESCRIPTION OF DRAWINGS

FIG. 1 is an external view of an all-solid-state secondary battery according to one embodiment of the present invention.

FIG. 2 is an external view of a laminate according to one embodiment of the present invention.

FIG. 3 is a schematic cross-sectional view of an example of the all-solid-state secondary battery according to one embodiment of the present invention.

FIG. 4 is a schematic cross-sectional view of another example of the all-solid-state secondary battery according to one embodiment of the present invention.

FIG. 5 is a schematic cross-sectional view of still another example of the all-solid-state secondary battery according to one embodiment of the present invention.

### DESCRIPTION OF EMBODIMENTS

Hereinafter, one embodiment of the present invention will be described in detail with reference to the drawings as appropriate. In the drawings used in the following description, there are cases in which illustration is simplified for convenience so that characteristics of the present embodiment can be easily understood, and dimensional ratios or the like of each of components may be different from actual ones. Materials, dimensions, and the like exemplified in the following description are merely examples, and the present embodiment is not limited thereto and can be implemented with appropriate modifications within a range in which the effects of the present invention are achieved. For example, configurations described in different embodiments can be appropriately combined and implemented.

As all-solid-state secondary batteries, an all-solid-state lithium ion secondary battery, an all-solid-state sodium ion secondary battery, an all-solid-state magnesium ion secondary battery, and the like can be mentioned. Hereinafter, an all-solid-state lithium ion secondary battery will be described as an example, but the present invention is generally applicable t) any all-solid-state secondary battery.

### (All-Solid-State Secondary Battery)

An all-solid-state secondary battery includes a laminate having a first electrode layer, a second electrode layer, and a solid electrolyte layer. Either one of the first electrode layer and the second electrode layer functions as a positive electrode, and the other functions as a negative electrode. Hereinafter, for ease of understanding, the first electrode layer will be described as a positive electrode layer, and the second electrode layer will be described as a negative electrode layer.

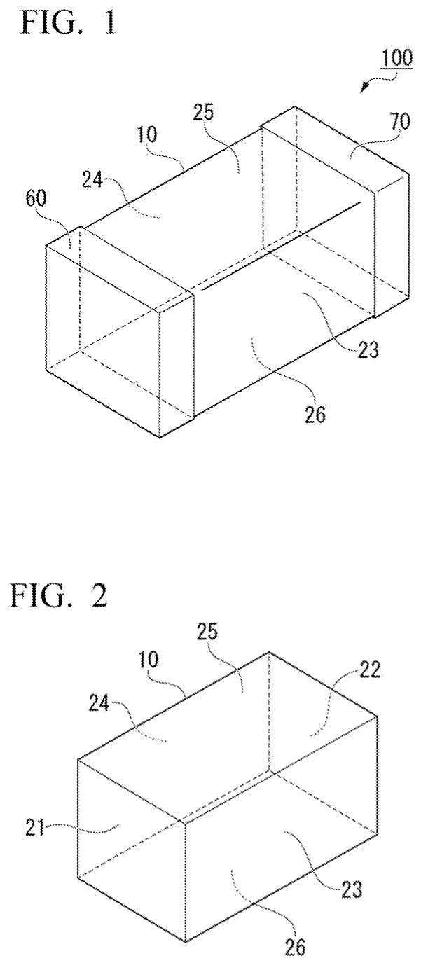

An all-solid-state secondary battery of the present embodiment will be described with reference to FIGS. 1 to 3.

As illustrated in FIG. 1, an all-solid-state secondary battery 100 of a first embodiment includes a laminate 10, an outer positive electrode 60, and an outer negative electrode 70. As illustrated in FIG. 2, the laminate 10 is a hexahedron, and has four side surfaces including a side surface 21, a side surface 22, a side surface 23, and a side surface 24, an upper surface 25, and a lower surface 26. Further, the outer positive electrode 60 and the outer negative electrode 70 are formed on any pair of facing side surfaces. Further, in the embodiment of the all-solid-state secondary battery 100 of FIG. 1, the outer positive electrode 60 is formed on the side surface 21 and the outer negative electrode 70 is formed on the side surface 22 in the laminate 10 of FIG. 2.

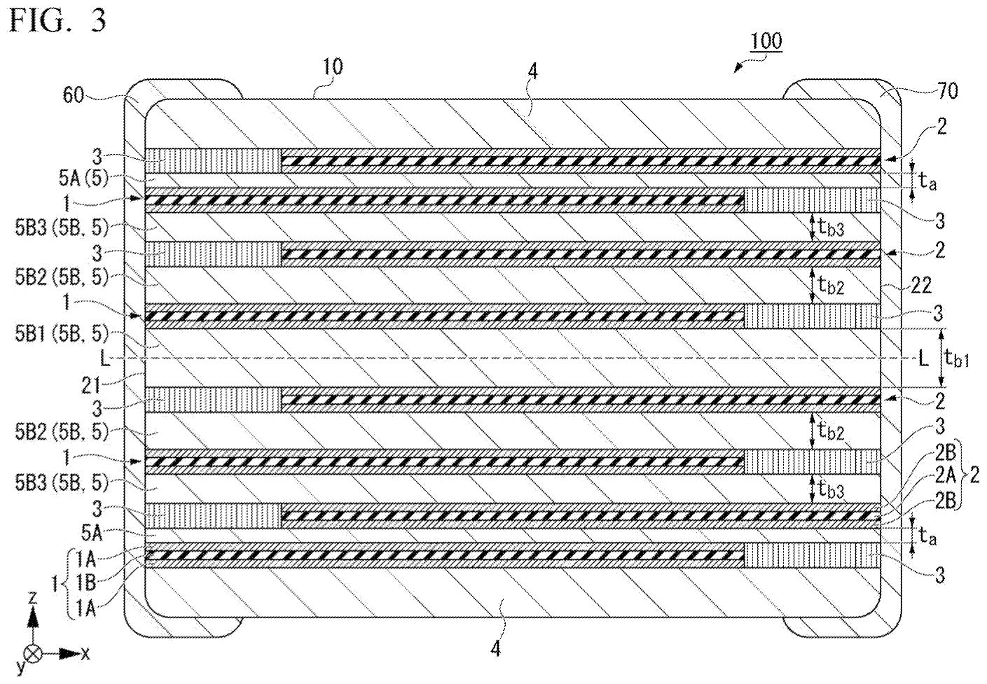

Next, the all-solid-state secondary battery 100 of the present embodiment will be described with reference to the cross-sectional view of FIG. 3. In FIG. 3, L-L is a line indicating a center (middle) position of the laminate 10 in a lamination direction (z direction).

The all-solid-state secondary battery 100 includes the laminate 10 in which a plurality of positive electrode layers 1 each having a positive electrode current collector layer 1A, a positive electrode active material layer 1B, and a side margin layer 3, and a plurality of negative electrode layers 2 each having a negative electrode current collector layer 2A, a negative electrode active material layer 2B, and the side margin layer 3 are alternately laminated with solid electrolyte layers 5 interposed therebetween.

A plurality of solid electrolyte layers 5 includes an outermost solid electrolyte layer 5A disposed on both end sides (the upper surface 25 side and the lower surface 26 side) of the laminate 10 in the lamination direction (z direction) and having a smallest thickness among the plurality of solid electrolyte layers, and an inner solid electrolyte layer 5B disposed inward (on the center line L-L side) of the outermost solid electrolyte layer 5A and having a thickness larger than that of the outermost solid electrolyte layer 5A. Here, the “solid electrolyte layer” in the “plurality of solid electrolyte layers” refers to one interposed between the positive electrode layer and the negative electrode layer. Therefore, an “outer layer (reference sign 4 in FIG. 1)” to be described later is not included in the “solid electrolyte layer” in the “plurality of solid electrolyte layers”. Of the plurality of solid electrolyte layers 5, the outermost solid electrolyte layers 5A indicate solid electrolyte layers disposed on an outermost side on a +z side and an outermost side on a −z side in the lamination direction (z direction) of the laminate 10.

In the all-solid-state secondary battery 100 illustrated in FIG. 3, outer layers 4 are provided at both ends as outermost layers of the laminate 10 in the lamination direction (z direction). In this example, the outer layers 4 on both ends have the same thickness.

Although the all-solid-state secondary battery generates heat due to charging or discharging, when the vicinity of a layer disposed on an outer side and a layer disposed inward (for example, in the vicinity of the central portion) of the layer disposed on the outer side are compared, the layer disposed on the outer side easily dissipates heat while the layer disposed on the inward side does not easily dissipate heat compared to the layer disposed on the outer side, and therefore the layer on the inward side has a higher temperature.

Therefore, in the all-solid-state secondary battery of the present invention, when a configuration in which a solid electrolyte layer (inner solid electrolyte layer) thicker than the outermost solid electrolyte layer is disposed inward of the outermost solid electrolyte layer is employed, charging/discharging and heat generation at a portion on the central portion side are curbed, furthermore, a more uniform temperature distribution is achieved in the entire all-solid-state secondary battery, and thereby cycle characteristics are improved.

In the present specification, the “inner solid electrolyte layer” refers to a solid electrolyte layer that is thicker than the “outermost solid electrolyte layer” and disposed inward of the outermost solid electrolyte layer. Therefore, even if a solid electrolyte layer is disposed inward of the outermost solid electrolyte layer, the solid electrolyte layer having the same thickness as the “outermost solid electrolyte layer” does not correspond to the “inner solid electrolyte layer”. In the following, a solid electrolyte layer that is disposed inward of the outermost solid electrolyte layer and has the same thickness as the “outermost solid electrolyte layer” may be referred to as a “same-thickness solid electrolyte layer” to be distinguished from the “inner solid electrolyte layer” or the “outermost solid electrolyte layer”.

Also, since the number of layers of the “outermost solid electrolyte layer” is about the solid electrolyte layers disposed on both end sides (the upper surface 25 side and the lower surface 26 side) of the laminate 10 in the lamination direction (z direction), the number of layers of the “outermost solid electrolyte layer” is two including one layer on the upper surface 25 side and one layer on the lower surface 26 side.

Further, since the “outermost solid electrolyte layer” is the thinnest solid electrolyte layer among the plurality of solid electrolyte layers, a configuration including a solid electrolyte layer thinner than the outermost solid electrolyte layer on an inner side of the outermost solid electrolyte layer does not correspond to the all-solid-state secondary battery of the present invention.

The number of layers of the “inner solid electrolyte layer” is not limited, and may be one or more layers. Also, a disposition position of the “inner solid electrolyte layer” need only be on an inner side with respect to the “outermost solid electrolyte layer,” and there is no restriction on the disposition configuration even when a plurality of inner solid electrolyte layers are provided.

The all-solid-state secondary battery 100 illustrated in FIG. 3 has a configuration in which five inner solid electrolyte layers 511 having the same thickness are disposed symmetrically in the lamination direction (z direction) with respect to the center line L-L. In FIG. 3, the center line L-L is a line indicating a center (middle) position in the lamination direction (z direction) of the laminate 10, and since the outer layers 4 at both ends have the same thickness, the center line L, is also a line indicating a center (middle) position in the lamination direction (z direction) of the laminate 10 excluding the outer layers 4.

In the all-solid-state secondary battery 100 illustrated in FIG. 3, when a thickness of the outermost solid electrolyte layer 5A is tₐ, and thicknesses of the five inner solid electrolyte layers 5B (5B3, 5B2, 5B1, 5B2, 5B3) are t_{b1}, t_{b2}, and t_{b3} in order outward from the center line, a magnitude relation of tₐ<t_{b3}<t_{b2}<t_{b1} is established. The thickness of the inner solid electrolyte layer 5B is 1 times or more, and preferably 1.2 times or more the thickness of the outermost solid electrolyte layer 5A. Also, although there is no upper limit to the thickness of the inner solid electrolyte layer 5B, practically, twice or less the thickness of the outermost solid electrolyte layer 5A is conceivable.

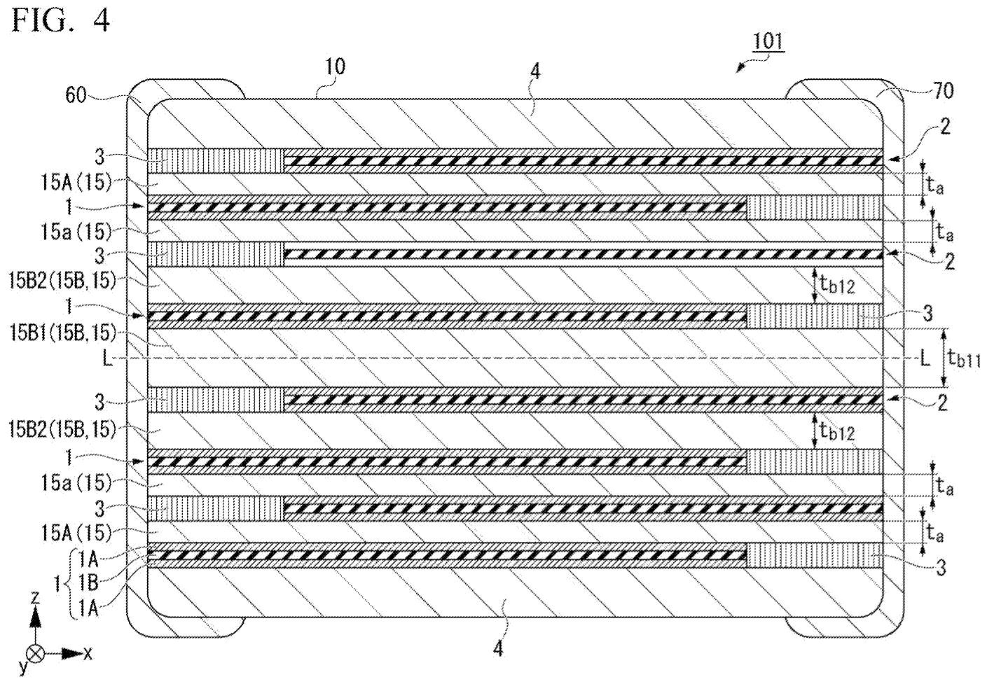

In the all-solid-state secondary battery 100 illustrated in FIG. 3, the plurality of solid electrolyte layers 5 are formed of the outermost solid electrolyte layers 5A and the inner solid electrolyte layers 5B, and do not include a solid electrolyte layer that does not correspond to either the outermost solid electrolyte layer 5A or the inner solid electrolyte layer 5B, but, as an example illustrated in FIG. 4, a configuration in which a solid electrolyte layer (that is, the “same-thickness solid electrolyte layer”) having the same thickness as the outermost solid electrolyte layer and disposed inward of the outermost solid electrolyte layer may be used.

That is, in an all-solid-state secondary battery 101 illustrated in FIG. 4, a plurality of solid electrolyte layers 15 are configured to include a solid electrolyte layer 15a having the same thickness as an outermost solid electrolyte layer and disposed inward of an outermost solid electrolyte layer 15A in addition to the outermost solid electrolyte layer 15A and inner solid electrolyte layers 153.

In the all-solid-state secondary battery 101 illustrated in FIG. 4, the outermost solid electrolyte layer 15A and the solid electrolyte layer 15a adjacent thereto have an equal thickness of tₐ, and then an inner solid electrolyte layer 15B2 having a thickness of t_{b12} (>tₐ) and an inner solid electrolyte layer 1581 having a thickness of t_{b11} (>t_{b12}) are disposed in order toward the center line side.

The all-solid-state secondary battery 100 illustrated in FIG. 3 and the all-solid-state secondary battery 101 illustrated in FIG. 4 have a configuration in which an inner solid electrolyte layer disposed closer to the central portion (a portion including the center line L-L) has a larger thickness. That is, the all-solid-state secondary battery 100 and the all-solid-state secondary battery 101 have a configuration in which the plurality of inner solid electrolyte layers gradually (in stages) increase in thickness from the outside toward the inside. Due to the configuration in which the plurality of inner solid electrolyte layers gradually increase in thickness, charging/discharging and heat generation can be controlled more uniformly.

The all-solid-state secondary battery 100 and the all-solid-state secondary battery 101 are examples having five inner solid electrolyte layers, but the number of inner solid electrolyte layers is not limited thereto.

In the plurality of inner solid electrolyte layers, when a thickness of an n-th inner solid electrolyte layer at a position on an outward side counted from the inner solid electrolyte layer disposed at the central portion in the lamination direction is t_{bn}, the following expression is preferably satisfied.

t_{b(n+1)}<t_{bn}<t_{b(n+1)}×2

Here, the inner solid electrolyte layer disposed at the central portion in the lamination direction is assumed to be a first inner solid electrolyte layer, and a thickness thereof is assumed to be t_{b1}.

The inequality sign on the left side indicates that the inner solid electrolyte layer disposed on an outer side is thicker than the inner solid electrolyte layer disposed at the central portion. The inequality sign on the right side indicates that a thickness of the inner solid electrolyte layer disposed at the central portion is less than twice a thickness of an inner solid electrolyte layer adjacent to an outer side of the inner solid electrolyte layer. If a difference in thickness between adjacent inner solid electrolyte layers is too large, a uniform temperature distribution is not easily obtained for the entire all-solid-state secondary battery, and therefore it is preferable that a change in thickness be more continuous. When solid electrolyte layers thicker than the outermost solid electrolyte layer are provided on an inner side of the outermost solid electrolyte layer, and a gradient is given to the thicknesses of the solid electrolyte layers, a temperature distribution inside the chip can be made uniform, local deterioration can be curbed, and thereby the cycle characteristics can be improved.

When the total number of the outermost solid electrolyte layer and the inner solid electrolyte layers is p, and the number of the inner solid electrolyte layers is q, the following expression is preferably satisfied.

3≤q≤p−2

When the number of the inner solid electrolyte layers each having a thick layer to curb heat generation is three or more, heat generation inside the chip can be curbed, a more uniform temperature distribution can be obtained for the entire all-solid-state secondary battery, and local deterioration is curbed, thereby improving the cycle characteristics.

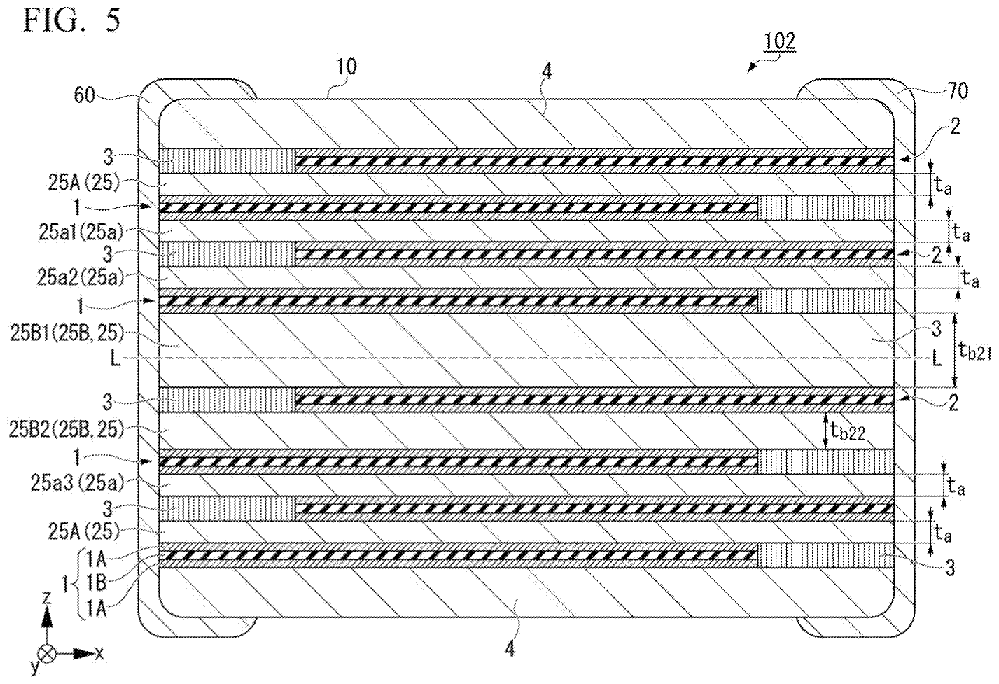

The all-solid-state secondary battery 100 illustrated in FIG. 3 and the all-solid-state secondary battery 101 illustrated in FIG. 4 have a configuration in which the inner solid electrolyte layers having the same thickness are symmetrically disposed in the lamination direction (z direction) with respect to the center line L-L, but a configuration in which the inner solid electrolyte layers are asymmetrically disposed in the lamination direction (z direction) with respect to the center line L-L may be used as an example illustrated in FIG. 5.

That, is, in an all-solid-state secondary battery 102 illustrated in FIG. 5, a plurality of solid electrolyte layers 25 are configured to include outermost solid electrolyte layers 25A, an inner solid electrolyte layer 25B1 disposed at a central portion, an inner solid electrolyte layer 15B2 disposed only on one side (lower side in the figure) with respect to the inner solid electrolyte layer 25B1, one layer (25a3) of a same-thickness solid electrolyte layer 25a having the same thickness as the outermost solid electrolyte layer disposed on one side (lower side in the figure) of the inner solid electrolyte layer 25B1, and two layers (25a1 and 25a2) of the same-thickness solid electrolyte layer 25a on the other side (upper side in the figure).

In the all-solid-state secondary battery 102 illustrated in FIG. 5, the outermost solid electrolyte layers 25A, the same-thickness solid electrolyte layers 25a1 and 25a3 adjacent thereto, and the same-thickness solid electrolyte layer 25a2 adjacent to the same-thickness solid electrolyte layer 25a1 all have the same thickness of tₐ, the inner solid electrolyte layer 25B2 having a thickness t_{b22} (>tₐ) larger than the thickness of the outermost solid electrolyte layer 25A is disposed adjacent to the same-thickness solid electrolyte layer 25a3, and the inner solid electrolyte layer 2581 having even larger thickness t_{b21} (>t_{b22}) is disposed at the central portion.

The all-solid-state secondary battery 102 illustrated in FIG. 5 has the inner solid electrolyte layer in the central portion (a portion including the center line L-L), but may be configured not to have the inner solid electrolyte layer in the central portion. That is, the all-solid-state secondary battery 102 may have an configuration in which the inner solid electrolyte layer is provided in the central portion, and disposition of the plurality of inner solid electrolyte layers is asymmetric with respect to the center line L-L, and may have a configuration in which the inner solid electrolyte layer is not provided in the central portion and disposition of the plurality of inner solid electrolyte layers is asymmetric with respect to the center line L-L.

The outermost solid electrolyte layer and the inner solid electrolyte layer preferably have solid electrolytes having the same crystal structure.

A solid electrolyte constituting the outermost solid electrolyte layer and the inner solid electrolyte layer preferably has a crystal structure of any one of a NaSICON type, a garnet type, and a perovskite type exhibiting high ionic conductivities. In addition, when the same-thickness solid electrolyte layer is provided, a solid electrolyte constituting the same-thickness solid electrolyte layer also preferably has a crystal structure of any one of a NaSICON type, a garnet type, and a perovskite type.

When the outermost solid electrolyte layer and the inner solid electrolyte layer include solid electrolytes having the same crystal structure, since the ionic conductivities are the same, charging and discharging reactions on both sides occur uniformly. Therefore, the cycle characteristics as the battery are improved.

Hereinafter, each layer constituting the all-solid-state secondary battery according to the present embodiment will be described in detail.

Further, as a description in the following, either one or both of the positive electrode active material and the negative electrode active material may be collectively referred to as an active material, either one or both of the positive electrode current collector layer and the negative electrode current collector layer may be collectively referred to as a current collector layer, either one or both of the positive electrode active material layer and the negative electrode active material layer may be collectively referred to as an active material layer, either one or both of the positive electrode and the negative electrode, may be collectively referred to as an electrode, and either one or both of the outer positive electrode and the outer negative electrode may be collectively referred to as an outer electrode.

### (Solid Electrolyte Layer)

The solid electrolyte layer (the outermost solid electrolyte layer, the inner solid electrolyte layer, and the same-thickness solid electrolyte layer when the same-thickness solid electrolyte layer is included) is not particularly limited, and may include a solid electrolyte having a crystal structure of any one selected from the group consisting of, for example, a NaSICON-type, a garnet-type, a perovskite-type, and a Lisicon-type crystal structures, or example, a general solid electrolyte material such as an oxide-based lithium ion conductor having a crystal structure of a NaSICON type, a garnet type, a perovskite type, and a Lisicon type can be used. As the solid electrolyte material, at least one type of an ion conductor (for example, Li₁₊ₓAlₓTi₂₋ₓ(PO₄)₃; LATP) having a NaSICON-type crystal structure containing at least Li (lithium), M (M is at least one of Ti (titanium), Zr (zirconium), Ge (germanium), Hf (hafnium), and Sn (tin)), P (phosphorus), and O (oxygen), an ion conductor (for example, Li₇La₃Zr₂O₁₂; LLZ) having a garnet-type crystal structure containing at least Li (lithium), Zr (zirconium), La (lanthanum), and O (oxygen) or an ion conductor having a garnet-type similar structure, an ion conductor (for example, Li₃ₓLa_{2/3-x}TiO₃; LLTO) having a perovskite-type structure containing at least Li (lithium), Ti (titanium). La (lanthanum), and O (oxygen), and a lithium ion conductor (for example, Li_{3.5}Si_{0.5}P_{0.5}O_{3.5}: LSPO) having a Lisicon-type crystal structure containing at least Li, Si, P, and O can be mentioned. That is, one type of these ion conductors may be used, or two or more types thereof may be used in combination.

As the solid electrolyte material of the present embodiment, it is preferable to use a lithium ion conductor having a NaSICON-type crystal structure, and is preferable to include a solid electrolyte material represented by, for example, Li₁₊ₓAlₓTi₂₋ₓ(PO₄)₃ (LATP, 0<x≤0.6)). LiZr₂(PO₄)₃ (LZP), LiTi₂(PO₄)₃ (LTP), Li₁₊ₓAlₓGe₂₋ₓ(PO₄)₃ (LAGP, 0<x≤0.6), and Li₁₊ₓYₓZr₂₋ₓ(PO₄)₃ (LYZP, 0<x≤0.6).

### (Positive Electrode Layer and Negative Electrode Layer)

For example, the plurality of positive electrode layers 1 and the plurality of negative electrode layers 2 are provided in the laminate 10, and face each other with the solid electrolyte layers interposed therebetween.

The positive electrode layer 1 includes the positive electrode current collector layer 1A, the positive electrode active material layer 1B, and the side margin layer 3. The negative electrode layer 2 includes the negative electrode current collector layer 2A and the negative electrode active material layer 2B.

### (Positive Electrode Active Material Layer and Negative Electrode Active Material Layer)

The positive electrode active material layer 18 and the negative electrode active material layer 2B according to the present embodiment contain known materials at least capable of absorbing and desorbing lithium ions as a positive electrode active material and the negative electrode active material. In addition, a conductive auxiliary agent and an ion-conductive auxiliary agent may be contained. It is preferable that the positive electrode active material and the negative electrode active material can efficiently absorb and desorb lithium ions. Thicknesses of the positive electrode active material layer 1B and the negative electrode active material layer 2B are not particularly limited, but can be in a range of 0.5 μm or more and 5.0 μm or less as an example of a guideline.

As the positive electrode active material and the negative electrode active material, for example, a transition metal oxide and a transition metal composite oxide can be mentioned. Specific examples of the positive electrode active material and the negative electrode active material include, for example, lithium manganese composite oxide Li₂MnₐMa₁₋ₐO₃ (0.8≤a<1, Ma=Co, Ni), lithium cobalt oxide (LiCoO₂), lithium nickel oxide (LiNiO₂), lithium manganese spinel (LiMn₂O₄), a composite metal oxide represented by a general expression; LiNiₓCo_{y}MnₓO₂ (x+y+z+a=1, 0≤x≤1, 0≤y≤1, 0≤z≤1), a lithium vanadium compound (LiV₂O₅), olivine type LiMbPO₄ (in which, Mb represents one or more elements selected from Co (cobalt), Ni (nickel), Mn (manganese), Fe (iron), Mg (magnesium), Nb (niobium), Ti (titanium), Al (aluminum), and Zr (zirconium)), lithium vanadium phosphate (Li₃V₂(PO₄)₃ or LiVOPO₄), Li-excess solid solution positive electrode represented by Li₂MnO₃-LiMcO₂ (Mc=Mn, Co, Ni), lithium titanate (Li₄Ti₅O₁₂), titanium oxide (TiO₂), a composite metal oxide represented by LiₛNiₜCoᵤAlᵥO₂ (0.9<s<1.3, 0.9<t+u+v<1.1), and the like.

The positive electrode active material and the negative electrode active material of the present embodiment preferably contain a phosphoric acid compound as a main component, and are preferably one or more of, for example, olivine type LiMbPO₄ (in which, Mb represents one or more elements selected from Co, Ni, Mn, Fe, Mg, Nb, Ti, Al, and Zr), lithium vanadium phosphate (LiVOPO₄, Li₃V₂(PO₄)₃, or Li_{d}(VO)(PO₄)₂), and lithium vanadium pyrophosphate (Li₂VOP₂O₇, Li₂VP₂O₇, or Li₉V₃(P₂O₇)₃(PO₄)₂).

Also, as the negative electrode active material, for example, an Li metal, an Li—Al alloy, an Li—In alloy, carbon, silicon (Si), a silicon oxide (SiOₓ), lithium titanate (Li₄Ti₅O₁₂), and a titanium oxide (TiO₂) can be used.

Here, there is no clear distinction between the active materials forming the positive electrode active material layer 1B and the negative electrode active material layer 2B, and when potentials of two types of compounds, that is, a compound in the positive electrode active material layer and a compound in the negative electrode active material layer, are compared, a compound exhibiting a higher potential can be used as the positive electrode active material, and a compound exhibiting a lower potential can be used as the negative electrode active material. Also, as long as it is a compound having both functions of absorbing and desorbing lithium ions at the same time, the same material may be used as the material forming the positive electrode active material layer 1B and the negative electrode active material layer 2B.

As the conductive auxiliary agent, carbon materials such as carbon black, acetylene black. Ketjen black, carbon nanotubes, graphite, graphene, and activated carbon, and metal materials such as gold, silver, palladium, platinum, copper, and tin can be mentioned.

The ion-conductive auxiliary agent is, for example, a solid electrolyte. As the solid electrolyte, specifically, the same material as the material used for, for example, the solid electrolyte layer 50 can be used.

When a solid electrolyte is used as the ion-conductive auxiliary agent, it is preferable to use the same material for the ion-conductive auxiliary agent, the outermost solid electrolyte layer, the inner solid electrolyte layer, and a solid electrolyte used for the same-thickness solid electrolyte layer when the same-thickness solid electrolyte layer is included.

### (Positive Electrode Current Collector and Negative Electrode Current Collector)

As materials forming the positive electrode current collector layer 1A and the negative electrode current collector layer 2A, it is preferable to use material having high conductivity and, for example, silver, palladium, gold, platinum, aluminum, copper, nickel, and the like are preferably used. Particularly, copper is more preferable because it does not easily react with an oxide-based lithium ion conductor, and furthermore, has an effect of reducing an internal resistance of the all-solid-state secondary battery. As the materials forming the positive electrode current collector layer 1A and the negative electrode current collector layer 2A, the same material may be used or different materials may be used. Thicknesses of the positive electrode current collector 1A and the negative electrode current collector 2A are not particularly limited, but can be in a range of 0.5 μm or more and 30 μm or less as an example of a guideline.

Also, it is preferable that the positive electrode current collector layer 1A and the negative electrode current collector layer 2A contain a positive electrode active material and a negative electrode active material, respectively.

When the positive electrode current collector layer 1A and the negative electrode current collector layer 2A respectively contain the positive electrode active material and the negative electrode active material, this is desirable because adhesions between the positive electrode current collector layer 1A and the positive electrode active material layer 1B and between the negative electrode current collector layer 2A and the negative electrode active material layer 2B are improved.

Proportions of the positive electrode active material and the negative electrode active material in the positive electrode current, collector layer 1A and the negative electrode current collector layer 2A of the present embodiment are not particularly limited as long as the current collectors perform their own functions, but a volume ratio between the positive electrode current collector and the positive electrode active material, or the negative electrode current collector and the negative electrode active material is preferably in a range of 90/10 to 70/30.

### (Side Margin Layer)

The side margin layer 3 is preferably provided to eliminate a step between the solid electrolyte layer and the positive electrode layer 1 and a step between the solid electrolyte layer and the negative electrode layer 2. Therefore, the side margin layer 3 indicates a region other than the positive electrode layer 1. Since the steps between the solid electrolyte layer, and the positive electrode layer 1 and the negative electrode layer 2 are eliminated due to the presence of the side margin layers 3, denseness of the electrodes is increased, and delamination and warpage due to calcination of the all-solid-state secondary battery do not easily occur.

A material forming the side margin layer 3 preferably contains, for example, the same material as the solid electrolyte layer. Therefore, the material forming the side margin layer 3 preferably contains an oxide-based lithium ion conductor having a crystal structure of a NaSICON type, a garnet type, or a perovskite type. As the lithium ion conductor having a NaSICON-type crystal structure, at least one type of an ion conductor having a NaSICON-type crystal structure containing at least Li, M (M is at least one of Ti (titanium), Zr (zirconium), Ge (germanium), Hf (hafnium), and Sn (tin)), P, and O, an ion conductor having a garnet-type crystal structure containing at least Li, Zr, La, and O. or a garnet-type similar structure, and an ion conductor having a perovskite-type structure containing at least Li, Ti, La, and O can be mentioned. That is, one type of these ion conductors may be used, or a plurality of types thereof may be used in combination.

### (Outer Layer)

The outer layer 4 is disposed on either one or both (both in FIG. 3) of regions on an outer side than either of the positive electrode layer 1 (the positive electrode current collector layer 1A) and the negative electrode layer 2 (the negative electrode current collector layer 2A) in a lamination direction. For the outer layer 4, the same material as the solid electrolyte layer may be used. Further, in the present embodiment, the lamination direction corresponds to the z direction in FIG. 3.

A thickness of the outer layer 4 is not particularly limited, but may be, for example, 20 μm or more and 100 μm or less. When the thickness is 20 μm or more, the all-solid-state secondary battery has a high capacity because the positive electrode layer 1 or the negative electrode layer 2 closest to a surface of the laminate 10 in the lamination direction is less likely to be oxidized due to an influence of the atmosphere in a calcination process, and has high reliability because sufficient humidity resistance is secured even in an environment such as a high temperature and high humidity. Also, when the thickness is 100 μm or less, the all-solid-state secondary battery has a high volumetric energy density.

(Method for Manufacturing all-Solid-State Secondary Battery)

The all-solid-state secondary battery of the present invention can be manufactured by the following procedure. A simultaneous calcination method may be used or a sequential calcination method may be used. The simultaneous calcination method is a method of making a laminate by laminating materials forming each layer and then collectively calcining them. The sequential calcination method is a method in which each layer is made in sequence and a calcination step is performed each time each layer is made. Use of the simultaneous calcination method can reduce the number of work steps of the all-solid-state secondary battery. Also, use of the simultaneous calcination method makes the obtained laminate dense. A case of using the simultaneous calcination method will be described below as an example.

The simultaneous calcination method includes a step of preparing a paste of each material constituting the laminate, a step of applying and drying the pastes to prepare green sheets, and a step of laminating the green sheets and simultaneously calcining the prepared laminate.

First, materials of the positive electrode current collector layer 1A, the positive electrode active material layer 1B, the outermost solid electrolyte layer, the inner solid electrolyte layer, the negative electrode current collector layer 2A, the negative electrode active material layer 2B, and the side margin layer 3 are each made into a paste. The method of making a paste is not particularly limited, but for example, a paste can be obtained by mixing a powder of each material with a vehicle. Here, the vehicle refers to a generic name for a medium in a liquid phase, and includes a solvent, a binder, and the like. A binder contained in the paste for forming a green sheet or a printing layer is not particularly limited, but a polyvinyl acetal resin, a cellulose resin, an acrylic resin, an urethane resin, a vinyl acetate resin, a polyvinyl alcohol resin, or the like can be used, and a slurry thereof can contain at least one of these resins.

Also, the paste may contain a plasticizer. Types of the plasticizer are not particularly limited, but phthalates such as dioctyl phthalate and diisononyl phthalate, or the like may be utilized.

By such a method, a positive electrode current collector layer paste, a positive electrode active material layer paste, a solid electrolyte layer paste, a negative electrode active material layer paste, a negative electrode current collector layer paste, and a side margin layer paste are made.

Next, a green sheet is made. The green sheet is obtained by applying the prepared paste onto a base material such as polyethylene terephthalate (PET) in a desired order, drying it if necessary, and peeling off the base material. A method of applying the paste is not particularly limited. For example, known methods such as screen printing, coating, transfer, and doctor blade can be employed.

The prepared solid electrolyte layer paste is applied on a substrate such as polyethylene terephthalate (PET) to a desired thickness and is dried as necessary to prepare a green sheet for a solid electrolyte (outermost solid electrolyte layer). Also for the inner solid electrolyte layer having a thickness larger than that of the outermost solid electrolyte layer, a green sheet for a solid electrolyte (inner solid electrolyte layer) is made by the same procedure. Also, for the same-thickness solid electrolyte layer, a green sheet for a solid electrolyte (same-thickness solid electrolyte layer) is made by the same procedure as necessary.

A method of making the green sheet for a solid electrolyte is not particularly limited, and known methods such as a doctor blade method, a die coater, a comma coater, and a gravure coater can be employed.

Next, the positive electrode active material layer 1B, the positive electrode current collector layer 1A, and the positive electrode active material layer 1B are printed and laminated in that order on the green sheet for a solid electrolyte by screen printing to form the positive electrode layer 1. Further, in order to fill a step between the green sheet for a solid electrolyte and the positive electrode layer 1, the side margin layer 3 is formed in a region other than the positive electrode layer 1 by screen printing to make a positive electrode unit (one in which the positive electrode layer 1 and the side margin layer 3 are formed on the solid electrolyte layer). The positive electrode unit is made for each of the outermost solid electrolyte layer, the inner solid electrolyte layer, and, if necessary, the same-thickness solid electrolyte layer.

The negative electrode unit can also be made by the same method as the positive electrode unit.

Then, the positive electrode unit and the negative electrode unit are laminated to a predetermined number of layers while being alternately offset so that one end of the positive electrode and one end of the negative electrode are not aligned, and thereby a laminated substrate formed of elements of an all-solid-state secondary battery is made. Further, outer layers can be provided on the laminated substrate on both main surfaces of the laminate as necessary. The same material as the solid electrolyte layer can be used for the outer layers, and for example, the green sheet for a solid electrolyte can be used. Also, the inner solid electrolyte layer may have only one layer, or may have a plurality of layers (at a plurality of positions). The inner solid electrolyte layer is preferably provided to divide the number of laminations of the elements into equal parts or substantially equal parts. For example, when one inner solid electrolyte layer is provided in a laminate having the number of laminations of 31, one inner solid electrolyte layer may be provided at a 16th layer. In this case, an all-solid-state secondary battery is obtained from the laminate having a configuration of one outermost, solid electrolyte layer/14 same-thickness solid electrolyte layers/one inner solid electrolyte layer/14 same-thickness solid electrolyte layers/one outermost solid electrolyte layer. Similarly, when three inner solid electrolyte layers are provided, the inner solid electrolyte layers may be provided at a 16th layer, and a 15th layer and a 17th layer sandwiching the 16th layer. In this case, an all-solid-state secondary battery is obtained from the laminate having a configuration of one outermost solid electrolyte layer/13 same-thickness solid electrolyte layers/three inner solid electrolyte layer/13 same-thickness solid electrolyte layers/one outermost solid electrolyte layer.

Also, a lamination position at which the inner solid electrolyte layer is provided is not necessary to divide the number of laminations into equal parts or substantially equal parts, and the inner solid electrolyte layer, which has a larger thickness than that of the outermost solid electrolyte layer, need only be provided at a lamination position on an inward side of the outermost solid electrolyte layer. When the inner solid electrolyte layer is provided, a more uniform temperature distribution is realized compared to an all-solid-state secondary battery in which only solid electrolyte layers with the same thickness are provided.

The manufacturing method described above is for manufacturing an all-solid-state secondary battery of a parallel type, and in a manufacturing method for an all-solid-state secondary battery of a series type, lamination may be made so that one end of the positive electrode and one end of the negative electrode are aligned, that is, without them being offset.

Further, the manufactured laminated substrate can be collectively pressed by a die press, a warm isostatic press (WIP), a cold isostatic press (CIP), an isostatic press, or the like to improve the adhesion. Pressurization is preferably performed while heating, and can be performed at, for example, 40 to 95° C.

The manufactured laminated substrate can be cut into laminates of uncalcined all-solid-state secondary batteries using a dicing device.

The laminate is sintered by debinding and calcining the laminate of the all-solid-state secondary battery. In the debinding and calcination, the calcination can be performed, for example, at a temperature of 600° C. to (000° C. in a nitrogen atmosphere. A retention time for the debinding and calcination is, for example, 0.1 to 6 hours.

Barrel polishing is performed by chamfering corners of the laminate for the purpose of preventing chipping and for exposing an end surface of the current collector layer. The barrel polishing may be performed on the laminate 10 of the uncalcined all-solid-state secondary battery, or may be performed on the laminate 10 after calcination. Barrel polishing methods include dry barrel polishing without using water and wet barrel polishing with water. When wet barrel polishing is performed, an aqueous solution such as water is separately supplied to a barrel polishing machine.

Conditions for barrel processing are not particularly limited, can be adjusted as appropriate, and may be performed within a range in which defects such as cracking and chipping do not occur in the laminate.

Further, outer electrodes (the outer positive electrode 60 and the outer negative electrode 70) can be provided to efficiently draw a current from the laminate 10 of the all-solid-state secondary battery. The outer electrodes are configured so that the outer positive electrode 60 and the outer negative electrode 70 are formed on a pair of facing side surface 21 and side surface 22 of the laminate 10. As a method of forming the outer electrode, a sputtering method, a screen printing method, a dip coating method, or the like can be mentioned. In the screen printing method and the dip coating method, an outer electrode paste containing a metal powder, a resin, and a solvent is made to be formed as an outer electrode. Next, a baking process for removing the solvent and a plating treatment for forming a terminal electrode on a surface of the outer electrode are performed. On the other hand, since the outer electrode and the terminal electrode can be directly formed by the sputtering method, a baking process and a plating treatment are not required.

The laminate 10 of the all-solid-state secondary battery described above may be sealed in, for example, a coin cell to enhance humidity resistance and impact resistance. A sealing method thereof is not particularly limited, and for example, the laminate after calcination may be sealed with a resin. Also, an insulator paste having an insulating property such as Al₂O₃ may be applied or dip-coated around the laminate, and the insulator paste may be heat-treated for the sealing.

Further, in the above-described embodiment, a manufacturing method of an all-solid-state secondary battery having a process of forming a side margin layer using the side margin layer paste has been exemplified, but the manufacturing method of an all-solid-state secondary battery according to the present embodiment is not limited to the example. For example, the process of forming the side margin layer using the side margin layer paste may be omitted. The side margin layer may be formed by, for example, deformation of the solid electrolyte layer paste during the manufacturing process of the all-solid-state secondary battery.

While the embodiments according to the present invention have been described in detail above, the present invention is not limited to the above-described embodiments and various modifications can be made.

### EXAMPLES

Hereinafter, the present invention will be described in more detail using examples and comparative examples on the basis of the above-described embodiments, but the present invention is not limited to these examples. Further, “parts” denoted in an input amount of a material in preparing a paste means “parts by mass” unless otherwise specified.

### Example 1

### (Manufacture of Positive Electrode Active Material and Negative Electrode Active Material)

A positive electrode active material and a negative electrode active material were prepared by the following procedure. Using Li₂CO₃, V₂O₅, and NH₄H₂PO₄ as starting materials, wet-mixing was performed with a ball mill for 16 hours, and this mixed one was dehydrated and dried. The obtained powder was calcined at 850° C. for two hours in a nitrogen-hydrogen mixed gas, wet-pulverized with the ball mill for 16 hours again after the calcination, and finally dehydrated and dried to obtain powders of the positive electrode active material and the negative electrode active material.

As a result of X-ray diffraction (XRD) measurement and inductively coupled plasma (ICP) emission spectroscopy analysis for the obtained active material, it was ascertained to be vanadium lithium phosphate of Li₃V₂(PO₄)₃. Further, in identification of an X-ray diffraction pattern thereof, JCPDS card 74-3236: Li₃V₂(PO₄)₃ was referred to.

### (Preparation of Positive Electrode Active Material Paste and Negative Electrode Active Material Paste)

A positive electrode active material paste and a negative electrode active material paste were prepared by adding 15 parts of ethyl cellulose as a binder and 65 parts of dihydroterpineol as a solvent to 100 parts of powders of the positive electrode active material and the negative electrode active material that have been obtained together, and mixing and dispersing them.

### (Preparation of Solid Electrolyte Paste)

A solid electrolyte was made by the following procedure. Using Li₂CO₃ (lithium carbonate), TiO₂ (titanium oxide), Al₂O₃ (aluminum oxide), and NH₄H₂PO₄ (ammonium dihydrogen phosphate) as starting materials, each material was weighed so that a molar ratio of Li, Al, Ti, and PO₄ was 1.3:0.3:1.7:3.0 (═Li:Al:Ti:PO₄). These were wet-mixed with a ball mill for 16 hours and then dehydrated and dried. The obtained powder was calcined at 800° for two hours in the atmosphere, wet-pulverized with the ball mill again for 16 hours again after the calcination, and finally dehydrated and dried to obtain a powder of the solid electrolyte.

As a result of analyzing the obtained powder of the solid electrolyte with an XRD device and an ICP emission spectroscope, it was ascertained to be Li_{1.3}Al_{0.3}Ti_{1.7}(PO₄)₃ (aluminum titanium lithium phosphate) having a NaSICON-type crystal structure. Further, in identification of an X-ray diffraction pattern thereof, JCPDS card 35-0754: LiTi₂(PO₄) was referred to.

100 parts of ethanol and 200 parts of toluene as solvents were added to 100 parts of the powder of the solid electrolyte, and this was wet-mixed with a ball mill. Thereafter, 16 parts of a polyvinyl butyral-based binder and 4.8 parts of benzyl butyl phthalate were added and then wet-mixed with a ball mill to prepare a solid electrolyte paste.

### (Manufacture of Solid Electrolyte Layer Sheet)

Two sheets of the outermost solid electrolyte layer was made by applying the solid electrolyte paste onto a PET film using a doctor blade-type sheet molding machine. At this time, the sheet of the outermost solid electrolyte layer is made to have a thickness of 5 μm when a laminate chip to be described later is formed. Also, a plurality of sheets were made by the same procedure to obtain two sheets of the inner solid electrolyte layer that would have a thickness of 6 μm when the laminate chip was formed, two sheets of the inner solid electrolyte layer that would have a thickness of 7 μm, and one sheet of the inner solid electrolyte layer that would have a thickness of 9 μm. Furthermore, a plurality of sheets were made by the same procedure to obtain 24 sheets of the same-thickness solid electrolyte layer that would have a thickness of 5 μm when the laminate chip was formed.

### (Preparation of Positive Electrode Current Collector Paste and Negative Electrode Current Collector Paste)

As a positive electrode current collector and a negative electrode current collector. Cu powder and the prepared powders of the positive electrode active material and the negative electrode active material were mixed to have a volume ratio of 80/20, thereafter 10 parts of ethyl cellulose as a binder and 50 parts of dihydroterpineol as a solvent were added to 100 parts of the mixture, and mixed and dispersed to make a positive electrode current collector layer paste and a negative electrode current collector layer paste.

### (Preparation of Outer Electrode Paste)

Cu powder, an epoxy resin, and a solvent were mixed and dispersed with a ball mill to prepare an outer electrode paste of a thermosetting type.

Using the sheet of the outermost solid electrolyte layer, the sheet of the inner solid electrolyte layer, the sheet of the same-thickness solid electrolyte layer, the positive electrode current collector paste, the negative electrode current collector paste, and the outer electrode paste, an all-solid-state secondary battery was made by the following procedure.

### (Manufacture of Positive Electrode Unit)

A positive electrode active material layer having a thickness of 5 μm was printed and formed on a part of a main surface of the sheet of the outermost solid electrolyte layer using screen printing, and dried at 80° C. for 10 minutes. A positive electrode current collector layer having a thickness of 5 μm was printed and formed on the positive electrode active material layer using screen printing, and dried at 80° C. for 10 minutes. Further, a positive electrode active material layer having a thickness of 5 μm was printed and formed on the positive electrode current collector layer using screen printing and dried at 80° C. for 10 minutes, and thereby a positive electrode layer in which the positive electrode current collector layer was sandwiched between the positive electrode active material layers was formed on a part of the main surface of the sheet of the outermost solid electrolyte layer. Next, a solid electrolyte layer (side margin layer) having substantially the same height as the positive electrode layer was printed and formed on the main surface, of the sheet of the outermost solid electrolyte layer in which the positive electrode layer was not printed and formed, and dried at 80° C. for 10 minutes. Next, when the PET film was peeled of, a positive electrode unit in which the positive electrode layer and the solid electrolyte layer were printed and formed on the main surface of the outermost solid electrolyte layer was made.

Similarly, a positive electrode unit in which the positive electrode layer and the solid electrolyte layer were printed and formed on a main surface of the same-thickness solid electrolyte layer was made.

### (Manufacture of Negative Electrode Unit)

A negative electrode unit was made by the same procedure as the positive electrode unit.

(Manufacture of all-Solid-State Secondary Battery)

The positive electrode unit and the negative electrode unit were laminated with one end of the positive electrode layer and one end of the negative electrode layer shifted from each other to form a laminate chip. At this time, the positive electrode unit and the negative electrode unit were alternately laminated in order so that the inner solid electrolyte layer having a thickness of 6 μm was disposed at a 14th layer and a 18th layer when the solid electrolyte layers were counted in order in the lamination direction provided that the solid electrolyte layer positioned at an end of one side (lower side) is referred to as a “first solid electrolyte layer,” the inner solid electrolyte layer having a thickness of 7 μm was disposed at a 15th layer and a 17th layer, the inner solid electrolyte layer having a thickness of 9 μm was disposed at a 16th layer, the inner solid electrolyte layer having a thickness of 5 μm was disposed at a first layer and a 31st layer, and the same-thickness solid electrolyte layer having a thickness of 5 μm was disposed at second to 13th layers and at 19th to 30th layers. Thereby, a laminated substrate formed of a total of 31 solid electrolyte layers including one outermost solid electrolyte layer/12 same-thickness solid electrolyte layers/five inner solid electrolyte layers/12 same-thickness solid electrolyte layers/one outermost solid electrolyte layer formed in that order in the lamination direction was made.

A plurality of sheets of the outermost solid electrolyte layer were laminated on the upper surface and the lower surface of the laminated substrate to provide outer layers formed of the solid electrolyte layers thereon respectively. Further, the outer layers provided on the upper surface and the lower surface were formed to have the same thickness.

Laminated chips were made by cutting the laminated substrate after it was thermocompression-bonded by a die press to enhance adhesion at each laminated interface. Next, the laminated chips were placed on a ceramic setter and retained at 600° C. for two hours in a nitrogen atmosphere for debinding. Next, the laminated chips were calcined by being held at 750° C. for two hours in a nitrogen atmosphere and were taken out after natural cooling.

### (Outer Electrode Forming Step)

An outer electrode paste of Cu was applied to an end surface of the laminated chip after the calcination, then was retained at 150° C. for 30 minutes to be thermally cured to form an outer electrode, and thereby an all-solid-state secondary battery according to example 1 was made.

### (Evaluation of Thickness of Solid Electrolyte Layer)

A thickness tₐ of the outermost solid electrolyte layer, a thickness t_{b} (t_{b1}, t_{b2}, t_{b3}, t_{b2′}, t_{b3′}) of the inner solid electrolyte layer, and a thickness of the same-thickness solid electrolyte layer of the all-solid-state secondary battery according to example 1 were calculated by an image analysis after a laminated cross-sectional image of the all-solid-state secondary battery was acquired by a field emission scanning electron microscope (FE-SEM). The laminated cross-sectional image was captured continuously in a vertical direction at a central portion of the all-solid-state secondary battery at a magnification of 700 times to capture the entire laminated portion. Further, a straight line perpendicular to the positive electrode active material layer 1B or the negative electrode active material layer 2B positioned at an end in the lamination direction was drawn in a center of the laminated cross-sectional image, and on the straight line, a length between the positive electrode active material layer 1B and the negative electrode active material layer 2B adjacent to each other was defined as a thickness of the solid electrolyte layer sandwiched between the positive electrode active material layer 1B and the negative electrode active material layer 2B adjacent to each other. In the present embodiment, the thickness of the solid electrolyte layer refers to a thickness of the solid electrolyte layer at a center of the laminate 10 in a width direction. Here, the width direction of the laminate is a direction in which the laminate 10 is sandwiched between the outer positive electrode 60 and the outer negative electrode 70, and refers to an x direction in FIG. 3. As a result of measuring the thickness, first to 13th and 19th to 31st solid electrolyte layers each have a thickness of 5 μm, 14th and 18th solid electrolyte layers each have a thickness of 6 μm, 15th and 17th solid electrolyte layers each have a thickness of 7 μm, and a 16th solid electrolyte layer has a thickness of 9 μm.

A thickness ratio between the outermost solid electrolyte layer and a thinnest inner solid electrolyte layer among the inner solid electrolyte layers was 1.2 times (6 μm/5 μm), and a thickness ratio between adjacent inner solid electrolyte layers was about 1.2 times (7 μm/6 μm) or about 1.3 times (9 μm/7 μm). Further, since the same-thickness solid electrolyte layer has the same thickness as the outermost solid electrolyte layer, a thickness ratio between the outermost solid electrolyte layer and a thinnest inner solid electrolyte layer among the inner solid electrolyte layers was the same as a thickness ratio between the inner solid electrolyte layer and a same-thickness solid electrolyte layer adjacent to the inner solid electrolyte layer.

### Comparative Example 1

An all-solid-state secondary battery according to comparative example 1 differs from that of example 1 in that 31 solid electrolyte layers all have the same thickness of 5 μm. That is, the all-solid-state secondary battery according to comparative example 1 does not include an inner solid electrolyte layer.

### Comparative Example 2

An all-solid-state secondary battery according to comparative example 2 differs from that of example 1 in that a first solid electrolyte layer has a thickness of 15 μm, and the other solid electrolyte layers have the same thickness of 5 μm. That is, the all-solid-state secondary battery according to comparative example 2 has a configuration in which, of two solid electrolyte layers disposed outermost, one solid electrolyte layer disposed outermost has a thickness of 5 μm and the other solid electrolyte layer disposed outermost has a thickness of 15 μm.

### Example 2

An all-solid-state secondary battery according to example 2 differs from that of example 1 in that 14th and 18th inner solid electrolyte layers each have a thickness of 8 μm, 15th and 17th inner solid electrolyte layers each have a thickness of 11 μm, and a 16th inner solid electrolyte layer has a thickness of 17 μm.

In the all-solid-state secondary battery according to example 2, a thickness ratio between the outermost solid electrolyte layer and a thinnest inner solid electrolyte layer among the inner solid electrolyte layers was 1.6 times (8 μm/5 μm), and a thickness ratio between adjacent inner solid electrolyte layers was about 1.4 times (11 μm/8 μm) or about 1.5 times (17 μm/11 μm).

### Example 3

An all-solid-state secondary battery according to example 3 differs from that of example 1 in that, five inner solid electrolyte layers all have the same thickness.

### Example 4

An all-solid-state secondary battery according to example 4 differs from that of example 1 in that 14th and 18th inner solid electrolyte layers each have a thickness of 11 μm, 15th and 17th inner solid electrolyte layers each have a thickness of 12 μm, and a 16th inner solid electrolyte layer has a thickness of 13 μm.

In the all-solid-state secondary battery according to example 4, a thickness ratio between the outermost solid electrolyte layer and a thinnest inner solid electrolyte layer among the inner solid electrolyte layers was 2.2 times (11 μm/5 μm), and a thickness ratio between adjacent inner solid electrolyte layers was about 1.1 times (12 μm/11 μm) or about 1.1 times (13 μm/12 μm).

### Example 5

An all-solid-state secondary battery according to example 5 differs from that of example 1 in that it has three inner solid electrolyte layers, 15th and 17th inner solid electrolyte layers each have a thickness of 6 μm, and a 16th inner solid electrolyte layer has a thickness of 7 μm.

In the all-solid-state secondary battery according to example 5, a thickness ratio between the outermost solid electrolyte layer and a thinnest inner solid electrolyte layer among the inner solid electrolyte layers was 1.2 times (6 μm/5 μm) and a thickness ratio between adjacent inner solid electrolyte layers was about 1.2 times (7 μm/6 μm).

### Example 6

An all-solid-state secondary battery according to example 6 differs from that of example 1 in that it has three inner solid electrolyte layers, 15th and 17th inner solid electrolyte layers each have a thickness of 8 μm, and a 16th inner solid electrolyte layer has a thickness of 11 μm.

In the all-solid-state secondary battery according to example 6, a thickness ratio between the outermost solid electrolyte layer and a thinnest inner solid electrolyte layer among the inner solid electrolyte layers was 1.6 times (8 μm/5 μm), and a thickness ratio between adjacent inner solid electrolyte layers was about 1.4 times (11 μm/8 μm).

### Example 7

An all-solid-state secondary battery according to example 7 differs from that of example 1 in that it has two inner solid electrolyte layers, a 15th inner solid electrolyte layer has a thickness of 6 μm, and a 16th inner solid electrolyte layer has a thickness of 7 μm.

In the all-solid-state secondary battery according to example 7, a thickness ratio between the outermost solid electrolyte layer and a thinnest inner solid electrolyte layer among the inner solid electrolyte layers was 1.2 times (6 μm/5 μm), and a thickness ratio between adjacent inner solid electrolyte layers was about 1.2 times (7 μm/6 μm).

### Example 8

An all-solid-state secondary battery according to example 8 differs from that of example 1 in that it has two inner solid electrolyte layers, a 15th inner solid electrolyte layer has a thickness of 8 μm, and a 16th inner solid electrolyte layer has a thickness of 11 μm.

In the all-solid-state secondary battery according to example 8, a thickness ratio between the outermost solid electrolyte layer and a thinnest inner solid electrolyte layer among the inner solid electrolyte layers was 1.6 times (8 μm/5 μm), and a thickness ratio between adjacent inner solid electrolyte layers was about 1.4 times (11 μm/8 μm).

### Example 9

An all-solid-state secondary battery according to example 9 differs from that of example 1 in that it has one inner solid electrolyte layer, and a 16th inner solid electrolyte layer has a thickness of 15 μm.

In the all-solid-state secondary battery according to example 9, a thickness ratio between the outermost solid electrolyte layer and the inner solid electrolyte layer was three times (15 μm/5 μm).

### Example 10

An all-solid-state secondary battery according to example 10 differs from that of example 1 in that it has one inner solid electrolyte layer, and a 20th inner solid electrolyte layer has a thickness of 15 μm.

In the all-solid-state secondary battery according to example 10, a thickness ratio between the outermost solid electrolyte layer and the inner solid electrolyte layer was three times (15 μm/5 μm).

### (Battery Evaluation)

The all-solid-state secondary batteries made in the present examples and comparative examples can be evaluated for the following battery characteristics.

### [Charge/Discharge Cycle Test]

An outer negative terminal and an outer positive terminal of the all-solid-state secondary battery made in each of the present examples and the comparative examples were sandwiched between measuring probes, and charging and discharging were performed under the charging/discharging conditions illustrated below. A charge/discharge current is denoted using a notation of C rate below. The C rate is denoted as nC (μA) (n is a numerical value), and means a current that can charge and discharge a nominal capacity (μAh) in 1/n (h). For example, 1C means a charge/discharge current that can charge the nominal capacity in one hour, and 2C means a charge/discharge current that can charge the nominal capacity in 0.5 h. For example, in a case of a lithium ion secondary battery with a nominal capacity of 100 μAh, a current of 0.1 C is 10 μA (expression: 100 μA×0.1=10 μA). Similarly, a current of 0.2C is 20 μA, and a current of 1C is 100 μA.

In an environment of 25° C. constant-current charging (CC charging) was performed until a battery voltage reached 1.6 V at a constant current of 0.2 C rate, and then the battery was discharged (CC discharging) until the battery voltage reached 0 V at a constant current of 0.2 C rate. The charging and discharging described above were regarded as one cycle, and a discharge capacity retention rate after repeating the charging and discharging up to 1000 cycles was evaluated as charge/discharge cycle characteristics. Further, the charge/discharge cycle characteristics in the present embodiment were calculated by the following expression (1).

Discharge capacity retention rate after 1000 cycles(%)=(Discharge capacity after 1000 cycles/Discharge capacity after 1 cycle)×100 (1)

### (Result)

Table 1 shows results of the charge/discharge cycle test for the all-solid-state secondary batteries according to examples 1 to 10 and comparative examples 1 and 2.

Based on Table 1, the all-solid-state secondary batteries according to examples 1 to 6 including three or more inner solid electrolyte layers at the central portion in the lamination direction had cycle characteristics of 90% or more.

Also, among the all-solid-state secondary batteries according to examples 1 to 6, the all-solid-state secondary batteries according to examples 1 to 4 including five or more inner solid electrolyte layers had higher cycle characteristics than the all-solid-state secondary batteries including three or more inner solid electrolyte layers.

Also, if example 1 and example 2 in which the same five layers of the inner solid electrolyte layer were provided were compared, example 1 in which the thickness ratio between adjacent inner solid electrolyte layers was about 1.2 times to about 1.3 times had higher cycle characteristics than example 2 in which the thickness ratio between adjacent inner solid electrolyte layers was about 1.4 times to about 1.5 times, if example 5 and example 6 in which the same three layers of the inner solid electrolyte layer were provided were compared, example 5 in which the thickness ratio between adjacent inner solid electrolyte layers was about 1.2 times had higher cycle characteristics than example 6 in which the thickness ratio between adjacent inner solid electrolyte layers was about 1.4 times. If example 7 and example 8 in which the same two layers of the inner solid electrolyte layer were provided were compared, example 7 in which the thickness ratio between adjacent inner solid electrolyte layers was about 1.2 times had higher cycle characteristics than example 8 in which the thickness ratio between adjacent inner solid electrolyte layers was about 1.4 times. From these results, it can be said that if a plurality of inner solid electrolyte layers are provided, the thickness ratio of adjacent inner solid electrolyte layers is preferably 1.3 times or less, and more preferably 1.2 times or less. When a difference in thickness is too large, since it is difficult for the entire all-solid-state secondary battery to generate heat uniformly, it is considered that this indicates that the thickness is preferably changed more smoothly.

Also, if example 1 and example 4 in which the same five layers of the inner solid electrolyte layer were provided were compared, example 1 in which the thickness ratio between adjacent inner solid electrolyte layers was about 1.2 times to about 1.3 times had higher cycle characteristics than example 4 in which the ratio was about 1.1 times and a difference in thickness was small compared to that in example 1. This result is considered to be due to a difference in thickness ratio between the outermost solid electrolyte layer and the thinnest inner solid electrolyte layer among the inner solid electrolyte layers. That is, the ratio is 2.2 times in example 4 while it being 1.2 times in example 1. The thickness ratio between the outermost solid electrolyte layer and the thinnest inner solid electrolyte layer among the inner solid electrolyte layers is preferably 1.2 times rather than 2.2 times. When the comparison between example 2 and example 4 are also considered, it is considered that the thickness ratio between the outermost solid electrolyte layer and the thinnest inner solid electrolyte layer among the inner solid electrolyte layers is preferably 1.6 times or less and more preferably 1.2 times or less.

Also, if example 9 and example 10 in which the same one layer of the inner solid electrolyte layer with the same thickness was provided were compared, example 9 in which the inner solid electrolyte layer was disposed at a central portion (16th layer) of the laminate in the lamination direction had higher cycle characteristics than example 10 in which the inner solid electrolyte layer was disposed at a position shifted (20th layer) from a central portion of the laminate in the lamination direction. Front this result, it was found that the inner solid electrolyte layer was preferably disposed at a central portion of the laminate in the lamination direction.

TABLE I

| | | Outermost solid | | | | | | | | | | Cycle |
|---|---|---|---|---|---|---|---|---|---|---|---|---|
| | Total | electrolyte layer | | Inner solid electrolyte layer | | | | | | | | characterisrics |
| | Number | | Thickness | | | t_{b} [symbol] | Thickness t_{b} (μm) of inner solid | | | | | of |
| | of | | tₐ | | Number | disposition | electrolyte layer | | | | | 1000 |
| | layers | Composition | (μm) | Composition | of layers | position | t_{b1} | t_{b2} | t_{b3} | t_{b} [symbol] | t_{b} [symbol] | times |
| Example 1 | 31 | LATP | 5 | LATP | 5 | 16th layer | 9 | 7 | 6 | 7 | 6 | 95 |
| Example 2 | 31 | LATP | 5 | LATP | 5 | 16th layer | 17 | 11 | 8 | 11 | 8 | 94 |
| Example 3 | 31 | LATP | 5 | LATP | 5 | 16th layer | 6 | 6 | 6 | 6 | 6 | 93 |
| Example 4 | 31 | LATP | 5 | LATP | 5 | 16th layer | 13 | 12 | 11 | 12 | 11 | 93 |
| Example 5 | 31 | LATP | 5 | LATP | 3 | 16th layer | 7 | 6 | — | 6 | — | 91 |
| Example 6 | 31 | LATP | 5 | LATE | 3 | 16th layer | 11 | 8 | — | 8 | — | 90 |
| Example 7 | 31 | LATP | 5 | LATP | 2 | 16th layer | 7 | 6 | — | — | — | 85 |
| Example 8 | 31 | LATP | 5 | LATP | 2 | 16th layer | 11 | 8 | — | — | — | 84 |
| Example 9 | 31 | LATP | 5 | LATP | 1 | 16th layer | 15 | | — | — | — | 82 |
| Example 10 | 31 | LATP | 5 | LATP | 1 | 20th layer | 15 | | | | | 81 |
| Comparative | 31 | LATP | 5 | LATP | 0 | — | — | — | — | — | — | 75 |
| example 1 | | | | | | | | | | | | |
| Comparative | 31 | LATP | 5 | LATP | 1 | 1st layer | 15 | — | — | — | — | 76 |
| example 2 | | | | | | | | | | | | |

[symbol]

indicates data missing or illegible when filed

### Example 11

An all-solid-state secondary battery according to example 11 differs from that of example 1 in that it has 29 inner solid electrolyte layers, second and 30th inner solid electrolyte layers each have a thickness of 6 μm, a thickness of the inner solid electrolyte layer increases by 1 μm in order from the above-described layers to an inner side (that is, third and 29th inner solid electrolyte layers each have a thickness of 7 μm, fourth and 28th inner solid electrolyte layers each have a thickness of 8 μm, fifth and 27th inner solid electrolyte layers each have a thickness of 9 μm, sixth and 26th inner solid electrolyte layers each have a thickness of 10 sin, seventh and 25th inner solid electrolyte layer, each have a thickness of 11 μm, eighth and 24th inner solid electrolyte layers each have a thickness of 12 μm, ninth and 23th inner solid electrolyte layers each have a thickness of 13 pun, tenth and 22th inner solid electrolyte layers each have a thickness of 14 μm, 11th and 21th inner solid electrolyte layers each have a thickness of 15 μm, 12th and 20th inner solid electrolyte layers each have a thickness of 16 μm, 13th and 19th inner solid electrolyte layers each have a thickness of 17 μm, 14th and 18th inner solid electrolyte layers each have a thickness of 18 μm, and 15th and 17th inner solid electrolyte layers each have a thickness of 19 μm) and, a 16th inner solid electrolyte layer has a thickness of 20 μm.

In the all-solid-state secondary battery according to example 11, a thickness ratio between the outermost solid electrolyte layer and an inner solid electrolyte layer adjacent thereto was 1.2 times (6 μm/5 μm), and furthermore, respective thickness ratios between adjacent inner solid electrolyte layers in order were about 1.2 times (7 μm/6 μm), about 1.1 times (8 μm/7 μm), about 1.1 times (9 μm/8 μm), about 1.1 times (10 μm/9 μm), about 1.1 times (11 μm/10 μm), about 1.1 times (12 μm/11 μm), about 1.1 times (13 μm/12 μm), about 1.1 times (14 μm/13 μm), about 1.1 times (15 μm/14 μm)), about 1.1 times (16 μm/15 μm), about 1.1 times (17 μm/16 μm), about 1.1 times (18 μm/17 μm), about 1.1 times (19 μm/18 μm), and about 1.1 times (20 μm/19 μm).

As a result of the charge/discharge cycle test, cycle characteristics of 1000 times were 96%. A thickness gradient of the inner solid electrolyte layers was also continuous, and a best value 96% as the cycle characteristics was achieved.

It was found that one in which a thickness gradient was continuously made to the outermost solid electrolyte layer had a more uniform temperature distribution and a more improved cycle characteristics.

### Examples 12 to 20

In all-solid-state secondary batteries according to examples 12 to 20, the all-solid-state secondary batteries were made in the same procedure as in example 1 except that a solid electrolyte material of any of the outermost solid electrolyte layer, the inner solid electrolyte layer, and the same-thickness solid electrolyte layer, or all solid electrolyte materials of them were changed to a material other than LATP, and a battery evaluation thereof was performed in the same procedure as in example 1.

### Example 12

In the all-solid-state secondary battery according to example 12, an all-solid-state secondary battery was made in the same procedure as in example 1 except that solid electrolyte materials of the outermost solid electrolyte layer, the inner solid electrolyte layer, and the same-thickness solid electrolyte layer were changed to LZP (LiZr₂(PO₄)₃), and a battery evaluation thereof was performed in the same procedure as in example 1. The solid electrolyte of LZP was made by the following synthesis method.

LZP was made by the same synthesis method as in example 1 by using Li₂CO₃ (lithium carbonate), ZrO₂ (zirconium oxide), and NH₄H₂PO₄ (ammonium dihydrogen phosphate) as starting materials, and weighing a molar ratio of Li, Zr, and PO₄ to be 1:2:3 (═Li:Zr:PO₄). It was ascertained from XRD measurement and an ICP analysis that the obtained solid electrolyte was LiZr₂(PO₄).

### Example 13

In the all-solid-state secondary battery according to example 13, an all-solid-state secondary battery was made in the same procedure as in example 1 except that solid electrolyte materials of the outermost solid electrolyte layer, the inner solid electrolyte layer, and the same-thickness solid electrolyte layer were changed to LLZ (Li₇La₃Zr₂O₁₂), and a battery evaluation thereof was performed in the same procedure as in example 1. The solid electrolyte of LLZ was made by the following synthesis method.

LLZ was made by the same synthesis method as in example 1 by using Li₂CO₃ (lithium carbonate), La₂O₃ (lanthanum oxide), and ZrO₂ (zirconium oxide) as starting materials, and weighing a molar ratio of Li, La, and Zr to be 7:3:2 (═Li:La:Zr). It was ascertained from XRD measurement and an ICP analysis that the obtained solid electrolyte was Li₇La₃Zr₂O₁₂.

### Example 14

In the all-solid-state secondary battery according to example 14, an all-solid-state secondary battery was made in the same procedure as in example 1 except that solid electrolyte materials of the outermost solid electrolyte layer, the inner solid electrolyte layer, and the same-thickness solid electrolyte layer were changed to LLTO (Li_{0.3}La_{0.55}TiO₃), and a battery evaluation thereof was performed in the same procedure as in example 1. The solid electrolyte of LLTO was made by the following synthesis method.

LLTO was made by the same synthesis method as in example 1 by using Li₂CO₃ (lithium carbonate). La₂O₃ (lanthanum oxide), and TiO₂ (titanium oxide) as starting materials, and weighing a molar ratio of Li, La, and Ti to be 0.3:0.55:1.0 (═Li:La:Ti). It was ascertained from XRD measurement and an ICP analysis that the obtained solid electrolyte was Li_{0.3}La_{0.55}TiO₃.

### Example 15

In the all-solid-state secondary battery according to example 15, an all-solid-state secondary battery was made in the same procedure as in example 1 except that solid electrolyte materials of the outermost solid electrolyte layer, the inner solid electrolyte layer, and the same-thickness solid electrolyte layer were changed to LSPO (Li_{3.5}Si_{0.5}P_{0.5}O4), and a battery evaluation thereof was performed in the same procedure as in example 1. The solid electrolyte of LSPO was made by the following synthesis method.

LSPO was made by using Li₂CO₃, SiO₂, and commercially available Li₃PO₄ as starting materials, weighing them so that a molar ratio was 2:1:1, wet-mixing them with water as a dispersion medium by a ball mill for 16 hours, and then dehydrating and drying them. The obtained powder was calcined at 950° C. for two hours in the atmosphere, wet pulverized with the ball mill for 16 hours again, and finally dehydrated and dried to obtain a powder of the solid electrolyte. It was ascertained from the results of XRD measurement and an ICP analysis that the above-described powder was Li_{3.5}Si_{0.5}P_{0.5}O₄ (LSPO).

### Examples 16 to 20

In all-solid-state secondary batteries according to examples 16 to 20, all-solid-state secondary batteries were made in the same procedure as in example 1 except that a solid electrolyte material of the inner solid electrolyte layer was changed to a material other than LATP while solid electrolyte materials of the outermost solid electrolyte layer and the same-thickness solid electrolyte layer were LATP, and battery evaluations thereof were performed in the same procedure as in example 1.

### Example 16

In the all-solid-state secondary battery according to example 16, an all-solid-state secondary battery was made in the same procedure as in example 1 except that a solid electrolyte material of the inner solid electrolyte layer was changed to LTP, and a battery evaluation thereof was performed in the same procedure as in example 1.

LTP was made by the same synthesis method as in example 1 by using Li₂CO₃ (lithium carbonate), TiO₂ (titanium oxide), and NH₄H₂PO₄ (ammonium dihydrogen phosphate) as starting materials, and weighing each material so that a molar ratio of Li, Ti, and PO₄ was 1.0:2.0:3.0 (═Li:Ti:PO₄). It was ascertained from XRD measurement and an ICP analysis that the obtained solid electrolyte was LiTi₂(PO₄)₃.

### Example 17

In the all-solid-state secondary battery according to example 17, an all-solid-state secondary battery was made in the same procedure as in example 1 except that a solid electrolyte material of the inner solid electrolyte layer was changed to LAGP, and a battery evaluation thereof was performed in the same procedure as in example 1.

LAGP was made by the same synthesis method as in example 1 except that the starting material was changed to GeO₂ instead of TiO₂, and a molar ratio of Li, Al, Ge, and PO₄ was weighed to be 1.3:0.3:1.7:3.0 (═Li:Al:Ge:PO₄). It was ascertained from XRD measurement and an ICP analysis that the obtained solid electrolyte was Li_{1.3}Al_{0.3}Ge_{1.7}(PO₄)₃.

### Example 18

In the all-solid-state secondary battery according to example 18, an all-solid-state secondary battery was made in the same procedure as in example 1 except that a solid electrolyte material of the inner solid electrolyte layer was changed to LYZP, and a battery evaluation thereof was performed in the same procedure as in example 1.

LYZP was made by the same synthesis method as in example 1 by using Li₂CO₃ (lithium carbonate), Y(NO₃)₃ (yttrium nitrate), ZrO(NO₃)₂·2H₂O (zirconium oxynitrate), and NH₄H₂PO₄ (ammonium dihydrogen phosphate) as starting materials, and weighing Li, Y, Zr, and PO₄ to have a molar ratio of 1.1:0.1:1.9:3.0 (═Li:Y:Zr:PO₄). It was ascertained from XRD measurement and an ICP analysis that the obtained solid electrolyte was Li_{1.3}Y_{0.3}Zr_{1.7}(PO₄)₃.

### Example 19

In the all-solid-state secondary battery according to example 19, an all-solid-state secondary battery was made in the same procedure as in example 1 except that a solid electrolyte material of the inner solid electrolyte layer was changed to LLZ, and a battery evaluation thereof was performed in the same procedure as in example 1.

### Example 20

In the all-solid-state secondary battery according to example 20, an all-solid-state secondary battery was made in the same procedure as in example 1 except that a solid electrolyte material of the inner solid electrolyte layer was changed to LATP+LGPT, and a battery evaluation thereof was performed in the same procedure as in example 1.

### (Result)

Table 2 shows results of the charge/discharge cycle test for the all-solid-state secondary batteries according to examples 12 to 20. For reference, example 1 was also shown in Table 2.

Based on Table 2, when the solid electrolyte materials of the outermost solid electrolyte layer, the inner solid electrolyte layer, and the same-thickness solid electrolyte layer were all the same, example 1 in which the solid electrolyte material was LATP was most excellent in cycle characteristics, and in cases (examples 12 to 15) of solid electrolyte materials other than that, the cycle characteristics were the same as each other.

Also, in cases (examples 16 to 20) in which the solid electrolyte materials of the outermost solid electrolyte layer and the same-thickness solid electrolyte layers were LATP, and the solid electrolyte material of the inner solid electrolyte layer was different from LATP, the cycle characteristics were the same as each other.

TABLE 2

| | | Outermost solid | | | | | | | | | | Cycle |
|---|---|---|---|---|---|---|---|---|---|---|---|---|
| | Total | electrolyte layer | | Inner solid electrolyte layer | | | | | | | | characterisrics |
| | Number | | Thickness | | | t_{b} [symbol] | Thickness t_{b} (μm) of inner solid | | | | | of |
| | of | | tₐ | | Number | disposition | electrolyte layer | | | | | 1000 |
| | layers | Composition | (μm) | Composition | of layers | position | t_{b1} | t_{b2} | t_{b3} | t_{b} [symbol] | t_{b} [symbol] | times |
| Example 1 | 31 | LATP | 5 | LATP | 5 | 16th layer | 8 | 7 | 6 | 7 | 6 | 95 |
| Example 12 | 31 | LZP | 5 | LZP | 5 | 16th layer | 8 | 7 | 6 | 7 | 6 | 94 |
| Example 13 | 31 | LLZ | 5 | LLZ | 5 | 16th layer | 8 | 7 | 6 | 7 | 6 | 94 |
| Example 14 | 31 | LLTO | 5 | LLTO | 5 | 16th layer | 8 | 7 | 6 | 7 | 6 | 94 |
| Example 15 | 31 | LSPO | 5 | LSPO | 5 | 16th layer | 8 | 7 | 6 | 7 | 6 | 94 |
| Example 16 | 31 | LATP | 5 | LTP | 5 | 16th layer | 8 | 7 | 6 | 7 | 6 | 92 |
| Example 17 | 31 | LATP | 5 | LAGP | 5 | 16th layer | 8 | 7 | 6 | 7 | 6 | 92 |
| Example 18 | 31 | LATP | 5 | LYZP | 5 | 16th layer | 8 | 7 | 6 | 7 | 6 | 92 |
| Example 19 | 31 | LATP | 5 | LLZ | 5 | 16th layer | 8 | 7 | 6 | 7 | 6 | 92 |
| Example 20 | 31 | LATP | 5 | LATP + | 5 | 16th layer | 8 | 7 | 6 | 7 | 6 | 92 |
| | | | | LAGP | | | | | | | | |

[symbol]

indicates data missing or illegible when filed

Although the present invention has been described in detail above, the above-described embodiments and examples are merely examples, and the invention disclosed herein includes various changes and modifications of the above-described specific examples.

### REFERENCE SIGNS LIST

1 Positive electrode layer
1A Positive electrode current collector
1B Positive electrode active material layer
2 Negative electrode layer
2A Negative electrode current collector
28 Negative electrode active material layer
3 Side margin layer
4 Outer layer
5 Solid electrolyte layer
5A, 15A, 25A Outermost solid electrolyte layer
51, 15B, 25B Inner solid electrolyte layer
15a, 25a Same-thickness solid electrolyte layer
60 Outer positive electrode
70 Outer negative electrode
10 Laminate
100, 101, 200 All-solid-state secondary battery

1-5. (canceled)

6. An all-solid-state secondary battery comprising a laminate which includes a plurality of positive electrode layers each including a positive electrode active material layer, a plurality of negative electrode layers each including a negative electrode active material layer, and a plurality of solid electrolyte layers each containing a solid electrolyte, and in which the positive electrode layers and the negative electrode layers are alternately laminated with the solid electrolyte layers interposed therebetween,
wherein the plurality of solid electrolyte layers include:
an outermost solid electrolyte layer (having a thickness of tₐ) disposed on both end sides of the laminate in a lamination direction and being thinnest among the plurality of solid electrolyte layers; and
an inner solid electrolyte layer (having a thickness of t_{bn}(1≤n)>tₐ) disposed inward relative to the outermost solid electrolyte layer and being thicker than the outermost solid electrolyte layer.

7. The all-solid-state secondary battery according to claim 6, comprising a plurality of inner solid electrolyte layers being thicker than the outermost solid electrolyte layer,
wherein in the plurality of inner solid electrolyte layers, an inner solid electrolyte layer disposed closer to a central portion in the lamination direction is thicker.

8. The all-solid-state secondary battery according to claim 6, comprising the plurality of inner solid electrolyte layers being thicker than the outermost solid electrolyte layer,
wherein when in the plurality of inner solid electrolyte layers, a thickness of an n-th inner solid electrolyte layer is t_{bn}, the n-th inner solid electrolyte layer being a n-th layer counted from the inner solid electrolyte layer disposed at the central portion in the lamination direction, and the following expression is satisfied.
t_{b(n+1)}<t_{bn}<t_{b(n+1)}×2

9. The all-solid-state secondary battery according to claim 6,
wherein, when a total number of the outermost solid electrolyte layers and the inner solid electrolyte layers is p, and the number of the inner solid electrolyte layers is q, the following expression is satisfied.
3≤q≤p−2

10. The all-solid-state secondary battery according to claim 6,
wherein the solid electrolyte has a crystal structure of any one of a NaSICON type, a garnet type, or a perovskite type.
